(19) United States
(12) Patent Application Publication
(10) Pub. No.: US 2007/0278947 A1
(43) Pub. Date: Dec. 6, 2007

(54) Light-emitting element, manufacturing method thereof, light-emitting device, and electronic device

(75) Inventor: Junichiro Sakata, Atsugi (JP)

Correspondence Address: COOK, ALEX, McFARRON, MANZO,;CUMMINGS & MEHLER, LTD., SUITE 2850, 200 WEST ADAMS STREET, CHICAGO, IL, 60606, US

(73) Assignee: Semiconductor Energy Laboratory Co., Ltd.

(21) Appl. No.: 11/807,495

(22) Filed: May 29, 2007

(30) Foreign Application Priority Data
Jun. 2, 2006 (JP) 2006-155473

(51) Int. Cl. H01J 1/62; H01J 63/04

(52) U.S. Cl. 313/506

(57) ABSTRACT

It is an object of the present invention to provide a manufacturing method for a light-emitting element that emits light at a plurality of emission wavelength peaks. Furthermore, it is an object of the present invention to provide a light-emitting device and electronic device in which color rendering is high. A manufacturing method for a light-emitting element includes the following steps: a step for forming a first electrode, a step for forming a light-emitting layer over the first electrode, a step for forming a second electrode over the light-emitting layer, and a step for performing heat treatment on the light-emitting layer; where the step for forming the light-emitting layer includes a step for forming a layer containing a host material and a layer containing a material acting as a luminescent center so that the two layers are in contact with each other.

### BACKGROUND OF THE INVENTION

1. Field of the Invention

The present invention relates to a light-emitting element that uses electroluminescence. In addition, the present invention relates to a light-emitting device and electronic device that each have a light-emitting element.

2. Description of the Related Art

In recent years, for display units in televisions, cellular telephones, digital cameras, and the like, planar and thin display units have been demanded, and for a display unit that meets this demand, display units that use self-emitting light-emitting elements have been attracting attention. For one kind of self-emitting light-emitting element, there is a light-emitting element that uses electroluminescence; emission of light from a light-emitting material can be obtained by application of a voltage to a light-emitting element where a light-emitting material is interposed between a pair of electrodes.

For this kind of self-emitting light-emitting element, pixel visibility is high compared to that of a liquid crystal display, there are advantages in that no backlight is needed and the like, and these self-emitting light-emitting elements are thought to be suitable for use as flat panel display elements. In addition, for this kind of light-emitting element, there is a huge advantage in that these light-emitting elements can be manufactured to be thin and lightweight. Furthermore, response speed being extremely fast is one of the characteristics, as well.

Moreover, because this kind of self-emitting light-emitting element can be formed into a membrane, by formation of an element with a large area, surface emission can easily be achieved. Because this characteristic is hard to achieve with point light sources represented by incandescent light bulbs and LEDs or with line light sources such as fluorescent lamps, the utility value for surface light sources, which can be applied to lighting and the like, is high.

Light-emitting elements that use electroluminescence are divided into whether the light-emitting material is an organic compound or an inorganic compound; generally, light-emitting elements using the former are referred to as organic EL elements, and light-emitting elements using the latter are referred to as inorganic EL elements.

Inorganic EL elements, according to those element structures, are grouped into dispersed inorganic EL elements and thin film inorganic EL elements. There is a difference between the two types in that the former type has a light-emitting layer in which particles of a light-emitting material are dispersed throughout a binder and the latter type has a light-emitting layer that includes a thin film of a light-emitting material, but there is a common point in that, for both types, electrons need to be accelerated by being placed in a strong electric field. It is to be noted that, for a mechanism with which emission of light can be achieved, there is light emission by donor-acceptor recombination utilizing a donor level and an acceptor level or light emission by localization utilizing innershell electron transition of metal ions. In general, there are many cases in which light emission by donor-acceptor recombination is used for dispersed inorganic EL elements and light emission by localization is used for thin film inorganic EL elements.

Light-emitting materials used in these kinds of inorganic EL elements are host materials, such as zinc sulfide, doped with an element, such as manganese, copper, or the like, that acts as a luminescent center; for a manufacturing method, for example, there is a manufacturing method described in Patent Document 1: Japanese Published Patent Application No. 2004-99881; in addition, for a manufacturing method of light-emitting materials containing a variety of elements which act as luminescent centers, for example, there is a manufacturing method described in Patent Document 2: Japanese Published Patent Application No. 2004-244636. However, when light-emitting materials manufactured by these kinds of manufacturing methods are used for thin film inorganic EL elements, a problem arises in which emission of light that has a plurality of emission wavelength peaks is difficult to obtain.

### SUMMARY OF THE INVENTION

In view of the foregoing problem, it is an object of the present invention to provide a manufacturing method of a light-emitting element which emits light that has a plurality of emission wavelength peaks. In addition, it is an object of the present invention to provide a light-emitting device and electronic device with high color rendering.

One structure of the present invention is a light-emitting element which has a light-emitting layer interposed between a pair of electrodes, where the light-emitting layer includes a plurality of layers, and the light-emitting layer has a layer that contains a material acting as a luminescent center and a layer containing a host material provided to be in contact with the layer containing a material acting as a luminescent center, where a material acting as a luminescent center which is the same as the aforementioned material acting as a luminescent center is diffused throughout a layer containing the host material.

In the above structure, any one of the following can be used for the host material: zinc sulfide, cadmium sulfide, calcium sulfide, yttrium sulfide, gallium sulfide, strontium sulfide, barium sulfide, zinc oxide, yttrium oxide, aluminum nitride, gallium nitride, indium nitride, zinc selenide, zinc telluride, barium aluminum sulfide, calcium gallium sulfide, strontium gallium sulfide, and barium gallium sulfide.

In addition, in the above structure, it is preferable that the layer containing a material acting as a luminescent center contain any one or a plurality of any of the following for the element acting as a luminescent center: copper, silver, gold, manganese, terbium, europium, thulium, cerium, praseodymium, samarium, erbium, aluminum, chlorine, and fluorine.

Furthermore, in the above structure, an insulating layer may be interposed between the pair of electrodes as well. For the insulating layer, a layer containing any one or a plurality of any of the following can be used: yttrium oxide, titanium oxide, aluminum oxide, hafnium oxide, tantalum oxide, silicon oxide, barium titanate, strontium titanate, lead titanate, silicon nitride, and zirconium oxide.

Moreover, in the category of the present invention, a light-emitting device that includes the light-emitting element described above is also included. The light-emitting device in the present specification includes an image display device, a light-emitting device, and a light source (also, a lighting system). In addition, a module in which an IC (integrated circuit) is directly mounted in a light-emitting element by a COG (Chip On Glass) method; a module in which a connector, for example, an FPC (Flexible Printed Circuit), TAB (Tape Automated Bonding) tape, or a TCP (Tape Carrier Package), is attached to a panel where a light-emitting element is formed; and a module in which a printed circuit board is provided ahead of a module in which one or some of this TAB tape or one of these TCPs is attached are all included in the light-emitting device.

In addition, in the category of the present invention, an electronic device using a light-emitting element of the present invention in a display is also included. Consequently, the electronic device of the present invention has the characteristic of having a display, where the display includes the aforementioned light-emitting element and a controlling means for controlling light emitted by the light-emitting element.

Another structure of the present invention is a manufacturing method of a light-emitting element that includes the following steps: a step for forming a first electrode; a step for forming a light-emitting layer over the first electrode; a step for forming a second electrode over the light-emitting layer; and a step for performing heat treatment of the light-emitting layer; where the step for forming the light-emitting layer includes a step for forming a layer containing a host material and a layer containing a material acting as a luminescent center where the layer containing a host material and the layer containing a material acting as a luminescent center are in contact with each other.

In the above structure, for the host material, any of the following can be used: zinc sulfide, cadmium sulfide, calcium sulfide, yttrium sulfide, gallium sulfide, strontium sulfide, barium sulfide, zinc oxide, yttrium oxide, aluminum nitride, gallium nitride, indium nitride, zinc selenide, zinc telluride, barium aluminum sulfide, calcium gallium sulfide, strontium gallium sulfide, and barium gallium sulfide.

Furthermore, in the above structure, in the layer containing a material acting as a luminescent center, for the element acting as a luminescent center, using any one or a plurality of any of the following is preferable: copper, silver, gold, manganese, terbium, europium, thulium, cerium, praseodymium, samarium, erbium, aluminum, chlorine, and fluorine.

Moreover, in the above structure, an insulating layer may also be provided between the pair of electrodes. For the insulating layer, a layer containing one or more of any of the following can be used: yttrium oxide, titanium oxide, aluminum oxide, hafnium oxide, tantalum oxide, silicon oxide, barium titanate, strontium titanate, lead titanate, silicon nitride, and zirconium oxide.

By the manufacturing method for a light-emitting element of the present invention, a light-emitting element which emits light that has a plurality of emission wavelength peaks can be obtained.

In addition, in the light-emitting device and electronic device of the present invention, because light is emitted at a plurality of emission wavelength peaks in each, a light-emitting device and an electronic device with high color rendering can be obtained.

### BRIEF DESCRIPTION OF THE DRAWINGS

FIG. 1 is a diagram illustrating a light-emitting element of the present invention.

FIG. 2 is a diagram illustrating a light-emitting element of the present invention.

FIG. 3 is a diagram illustrating a light-emitting element of the present invention.

FIG. 4 is a diagram illustrating a light-emitting device of the present invention.

FIG. 5 is a diagram illustrating a light-emitting device of the present invention.

FIG. 6 is a diagram illustrating a light-emitting device of the present invention.

FIGS. 7A and 7B are diagrams illustrating a light-emitting device of the present invention.

FIGS. 8A and 8B are diagrams illustrating a light-emitting device of the present invention.

FIGS. 9A and 9B are diagrams illustrating a light-emitting device of the present invention.

FIGS. 10A to 10D are diagrams illustrating an electronic device of the present invention.

FIG. 11 is a diagram illustrating a lighting system of the present invention.

FIGS. 12A to 12C are diagrams illustrating a lighting system of the present invention.

FIG. 13 is a diagram illustrating a lighting system of the present invention.

FIG. 14 is a diagram illustrating a lighting system of the present invention.

### DETAILED DESCRIPTION OF THE INVENTION

Embodiment Modes of the present invention will be explained below with reference to the accompanying drawings. However, it is to be easily understood that the present invention is not limited to the explanation below, and various changes and modifications will be apparent to those skilled in the art without any departure from the spirit and scope of the present invention. Therefore, it is to be understood that the present invention is not limited to the defined content of the Embodiment Modes explained below.

### Embodiment Mode 1

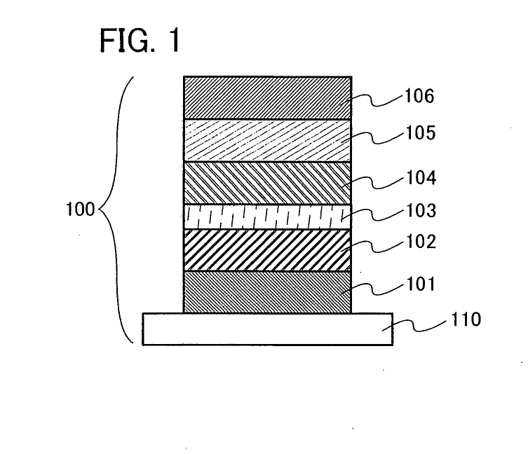

In the present embodiment mode, a manufacturing method for a thin film light-emitting element of the present invention will be explained using FIG. 1.

In FIG. 1, a thin film element 100 with a light-emitting layer includes, over a substrate 110, a first electrode 101 and a second electrode 106; a first insulating layer 102 and a second insulating layer 105 that are in contact with the first electrode 101 and the second electrode 106, respectively; and a first layer 103 and a second layer 104 formed between the first insulating layer 102 and second insulating layer 105. In the present embodiment mode, a manufacturing method for a light-emitting element in which, after thin film formation, heat treatment is performed, whereby emission of light from a light-emitting layer is obtained, will be explained hereinafter.

The substrate 110 is used as a base for a light-emitting element. For the substrate 110, for example, glass, quartz, plastic, or the like can be used. It is to be noted that if the substrate 110 functions as a base during a manufacturing process of a light-emitting element, other materials can be used in addition to these, and a material that can withstand the temperature of a heat treatment process that will be described later should be used.

For the first electrode 101 and the second electrode 106, a metal, an alloy, a conductive compound, or a mixture of any of these can be used. It is to be noted that, for obtaining surface emission of light, either one of the first electrode 101 or the second electrode 106 must be a transparent electrode or both of them must be transparent electrodes. For a transparent electrode, for example, electrodes of indium tin oxide (ITO), indium tin oxide containing silicon or silicon oxide (ITSO), indium zinc oxide (IZO), indium oxide containing tungsten oxide and zinc oxide (IWZO), and the like can be given. These conductive metal oxide films are formed using sputtering. For example, an IZO film can be formed by sputtering using indium oxide to which zinc oxide is added for a target of from 1 wt % to 20 wt % of zinc oxide. In addition, an IWZO film can be formed by sputtering using indium oxide to which tungsten oxide is added for a target of from 0.5 wt % to 5 wt % and zinc oxide is added for a target of from 0.1 wt % to 1 wt %. In addition to these, for a metal electrode, aluminum, silver, gold, platinum, nickel, tungsten, titanium, chromium, molybdenum, iron, cobalt, copper, palladium, or a nitride of one or a plurality of any of these metallic materials, for example, titanium nitride, or the like can be used. Furthermore, when a metallic electrode is used for the electrode that is transparent, even if the material is one which has low transmittance for visible light, by film formation at a thickness in the range of about 1 nm to 50 nm, preferably, of about 5 nm to 20 nm, the metallic electrode can be used as the transparent electrode. It is to be noted that, in addition to manufacturing of the electrode using sputtering, the electrode can be manufactured using vacuum deposition, CVD, or a sol-gel process.

The first electrode 103 is a layer containing a material acting as a luminescent center. For an element acting as a luminescent center, copper, silver, gold, manganese, terbium, europium, thulium, cerium, praseodymium, samarium, erbium, aluminum, chlorine, fluorine, or the like can be used; for a material containing an element acting as a luminescent center, a single one of these elements or a compound containing one or a plurality of any of these elements can be used. For a compound containing one or a plurality of any of these elements, copper sulfide, copper chloride, copper fluoride, copper sulfate, silver sulfide, silver chloride, silver fluoride, manganese sulfide, manganese chloride, manganese fluoride, manganese sulfate, manganese carbonate, manganese oxide, terbium chloride, terbium fluoride, europium oxide, europium chloride, europium fluoride, thulium oxide, thulium fluoride, praseodymium chloride, praseodymium fluoride, samarium oxide, samarium chloride, samarium fluoride, cerium oxide, cerium chloride, cerium fluoride, erbium oxide, erbium chloride, erbium fluoride, aluminum sulfide, aluminum chloride, or the like can be used. A thin film including a simple substance or compound of one or a plurality of these elements acting as luminescent centers is formed by a vacuum vapor deposition method, such as resistive evaporation, electron beam vapor deposition (EB vapor deposition), or the like; a sputtering method; a metal organic CVD method; a low-pressure hydride-transport CVD method; an atomic layer epitaxy method (ALE); or the like. Although there are no particular limitations on the thickness of the film, a film thickness in the range of 1 nm to 100 nm is preferable.

The second layer 104 is a layer that contains a host material. For the host material, a sulfide, an oxide, or a nitride can be used. For the sulfide, for example, zinc sulfide, cadmium sulfide, calcium sulfide, yttrium sulfide, gallium sulfide, strontium sulfide, barium sulfide, or the like can be used. In addition, for the oxide, for example, zinc oxide, yttrium oxide, or the like can be used. Furthermore, for the nitride, for example, aluminum nitride, gallium nitride, indium nitride, or the like can be used. Moreover, zinc selenide, zinc telluride, or the like may be used, or a compound of three elements, such as barium aluminum sulfide, calcium gallium sulfide, strontium gallium sulfide, barium gallium sulfide, or the like, may be used. A thin film using one or more of these kinds of host materials can be formed using a vacuum vapor deposition method, such as resistive heating evaporation, electron beam vapor deposition (EB vapor deposition), or the like; a sputtering method; a metal organic CVD method; a low-pressure hydride-transport CVD method; an atomic layer epitaxy method (ALE); or the like. Although there are no particular limitations on the thickness of the film, a film thickness in the range of 10 nm to 1000 nm is preferable.

It is to be noted that, in the host material, a material to which one or a plurality of elements acting as luminescent centers is added can be used. For example, ZnS to which Cu and Cl are added (ZnS:Cu,Cl), ZnS to which Mn is added (ZnS:Mn), or the like can be used.

Although there are no particular limitations on the first insulating layer 102 and the second insulating layer 105, it is preferable that dielectric strength voltage be high and film quality be high, and, moreover, it is preferable that the dielectric constant be high. For example, either a mixed film of any of the following or a film of two or more stacked films of any of the following can be used: yttrium oxide, titanium oxide, aluminum oxide, hafnium oxide, tantalum oxide, silicon oxide, barium titanate, strontium titanate, lead titanate, silicon nitride, and zirconium oxide. An insulating film of one or more of these can be formed by sputtering, vapor deposition, CVD, or the like. Although there are no particular limitations on the thickness of the film, a film thickness in the range of 10 nm to 1000 nm is preferable. When driving is to be performed by low voltage driving, a film thickness of 500 nm or less is preferable, and a film thickness of 100 nm or less is even more preferable.

Next, heat treatment of the thin film element 100 is performed. This heat treatment can be performed in vacuum or under atmospheric pressure, or it may be performed under an N₂ atmosphere or under an Ar atmosphere. It is to be noted that a heat treatment temperature of from 500° C. to 1200° C. is preferable. By performance of this heat treatment process, an element acting as a luminescent center contained in a layer containing a material acting as a luminescent center is dispersed throughout a layer containing a material acting as a host material, whereby a light-emitting layer is formed. It is to be noted that by control of temperature and time conditions, a light-emitting layer can be manufactured to which an element acting as a luminescent center of a different density distribution is added. In addition, when a host material to which an element acting as a luminescent center is added is used, a light-emitting element that has a plurality of luminescent colors can be manufactured; when each of the luminescent colors has a complementary color relationship, white light can be obtained.

In the manufacturing method of a light-emitting element of the present embodiment mode, by performance of heat treatment on a thin film element, a plurality of elements acting as luminescent centers can be easily added to a host material. As a result, a low-cost light-emitting element that emits light at a plurality of light emission wavelength peaks can be manufactured.

It is to be noted that the present embodiment mode can be combined with other embodiment modes as appropriate.

### Embodiment Mode 2

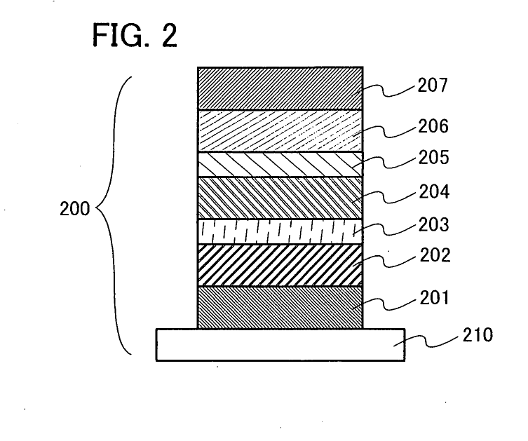

In the present embodiment mode, a thin film light-emitting element of the present invention will be described using FIG. 2.

In FIG. 2, a thin film element 200 with a light-emitting layer includes, over a substrate 210, a first electrode 201 and a second electrode 207; a first insulating layer 202 and a second insulating layer 206 that are in contact with the first electrode 201 and the second electrode 207, respectively; and a first layer 203, a second layer 204, and a third layer 205 formed between the first insulating layer 202 and the second insulating layer 206. As in Embodiment Mode 1, a manufacturing method of a light-emitting element in which, after thin film formation, heat treatment is performed, whereby emission of light from a light-emitting layer is obtained, will be explained hereinafter.

For the substrate 210, the first electrode 201 and second electrode 207, and the first insulating layer 202 and second insulating layer 206, the materials described in Embodiment Mode 1 can be used.

The first layer 203 and the third layer 205 are layers containing materials that act as luminescent centers, and the materials described in Embodiment Mode 1 can be used. It is to be noted that a material acting as a luminescent center that contains the same element acting as a luminescent center can be used, or, alternatively, a material acting as a luminescent center that contains a different element acting as a luminescent center can be used. When a material acting as a luminescent center that contains a different element acting as a luminescent center is used, a light-emitting element that emits light at a plurality of light emission wavelength peaks can be obtained.

The second layer 204 is a layer containing a host material, and the host materials described in Embodiment Mode 1 can be used. It is to be noted that, in the host material making up the second layer 204, a host material to which one or a plurality of elements acting as luminescent centers are added can be used.

Next, heat treatment is performed on the thin film element 200, and an element acting as a luminescent center contained in a layer containing a material acting as a luminescent center is diffused throughout the layer containing a host material. By diffusion of an element acting as a luminescent center from the first layer 203 and diffusion of an element acting as a luminescent center from the third layer 205, a light-emitting element that emits light with a plurality of light emission wavelength peaks can be obtained. It is to be noted that, by control of temperature and time conditions, a layer to which is added an element acting as a luminescent center of a concentration differing from the concentration of the element acting as a luminescent center contained in the second layer 204 can be manufactured. In addition, when a host material to which an element acting as a luminescent center is used is added, a light-emitting element with a plurality of luminescent colors can be obtained; when each of the luminescent colors has a complementary color relationship, white light can be obtained.

The light-emitting element of the present embodiment mode is a light-emitting element in which a plurality of elements acting as luminescent centers are added to a host material and the light-emitting element that emits light with a plurality of light emission wavelength peaks.

It is to be noted that the present embodiment mode can be combined with other embodiment modes accordingly.

### Embodiment Mode 3

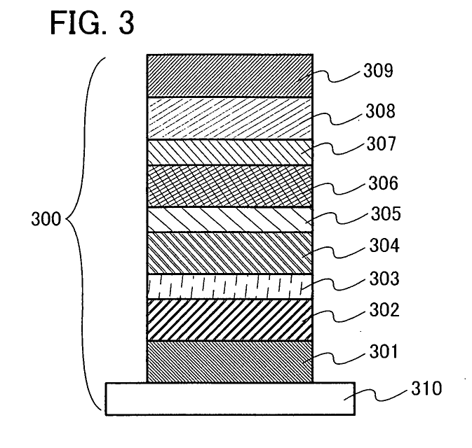

In the present embodiment mode, a thin film light-emitting element of the present invention will be explained using FIG. 3.

In FIG. 3, a thin film element 300 includes a first electrode 301 and a second electrode 309, a first insulating layer 302 and a second insulating layer 308 that are in contact with the first electrode 301 and the second electrode 309, respectively; and a first layer 303, a second layer 304, a third layer 305, a fourth layer 306, and a fifth layer 307 formed between the first insulating layer 302 and the second insulating layer 308, all formed over a substrate 310. As in Embodiment Mode 1, a manufacturing method of a light-emitting element in which, after thin film formation, heat treatment is performed whereby emission of light from a plurality of layers containing host materials which a light-emitting layer includes is obtained, will be explained hereinafter.

For the substrate 310, the first electrode 301 and second electrode 309, and the first insulating layer 302 and second insulating layer 308, the materials described in Embodiment Mode 1 can be used.

The first layer 303, the third layer 305, and the fifth layer 307 are layers containing materials acting as luminescent centers, and the materials described in Embodiment Mode 1 can be used. It is to be noted that a material acting as a luminescent center that contains the same element acting as a luminescent center may be used, or, alternatively, a material acting as a luminescent center that contains a different element acting as a luminescent center may be used. When a different element acting as a luminescent center is used, a light-emitting element that emits light with a plurality of light emission wavelength peaks can be obtained.

The second layer 304 and the fourth layer 306 are layers that each contain a host material, and the host materials described in Embodiment Mode 1 can be used. It is to be noted that the same host materials may be used, or, alternatively, different host materials may be used. When different host materials are used, even when the same element acting as a luminescent center is added, because the locations of the emission wavelength peaks are different, a light-emitting element with a plurality of emission wavelength peaks can be obtained.

Next, heat treatment is performed on the thin film element 300, and an element acting as a luminescent center contained in a layer containing a material acting as a luminescent center is diffused throughout the layer containing a host material. By diffusion of an element acting as a luminescent center from the first layer 303 and diffusion of an element acting as a luminescent center from the third layer 305, emission of light from a layer containing the host material of the second layer 304 can be obtained. In addition, by diffusion of an element acting as a luminescent center from the third layer 305 and diffusion of an element acting as a luminescent center from the fifth layer 307, emission of light from a layer containing the host material of the fourth layer 306 can be obtained. By obtainment of the emission of light from a plurality of layers containing host materials, a light-emitting element that emits light with a plurality of light emission wavelength peaks can be obtained. It is to be noted that, by control of temperature and time conditions, a layer to which is added an element acting as a luminescent center of a concentration differing from the concentration of the element acting as a luminescent center contained in the second layer or that of the element acting as a luminescent center contained in the fourth layer can be manufactured. In addition, when a host material to which an element acting as a luminescent center is added is used, because an even greater number of a plurality of elements acting as luminescent centers is included, a light-emitting element that emits light covering all wavelengths of the visible light region of the electromagnetic spectrum can be obtained.

The light-emitting element of the present embodiment mode is a light-emitting element in which a plurality of elements acting as luminescent centers are added to a plurality of host materials and a light-emitting element that emits light with a plurality of light emission wavelength peaks.

It is to be noted that the present embodiment mode can be combined with other embodiment modes accordingly.

### Embodiment Mode 4

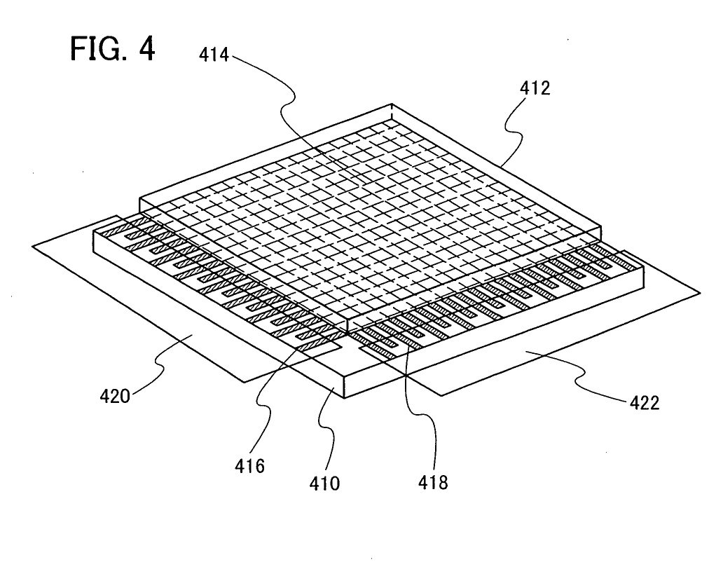

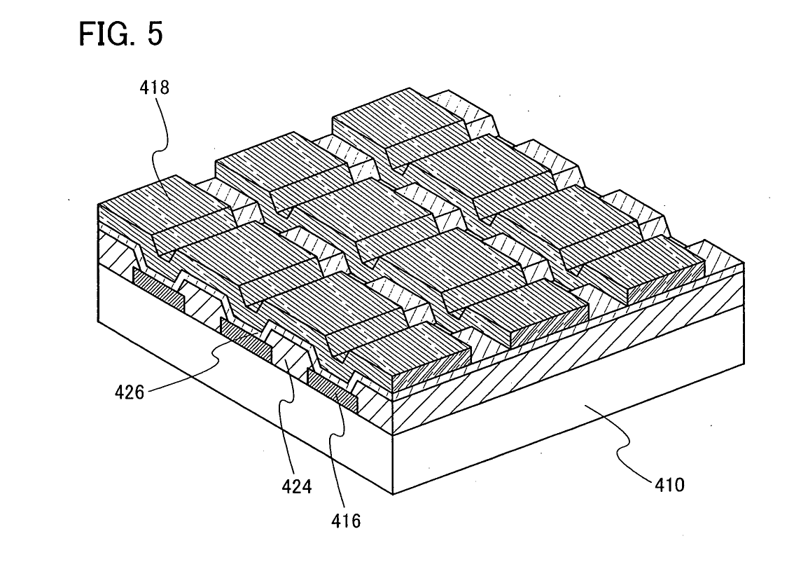

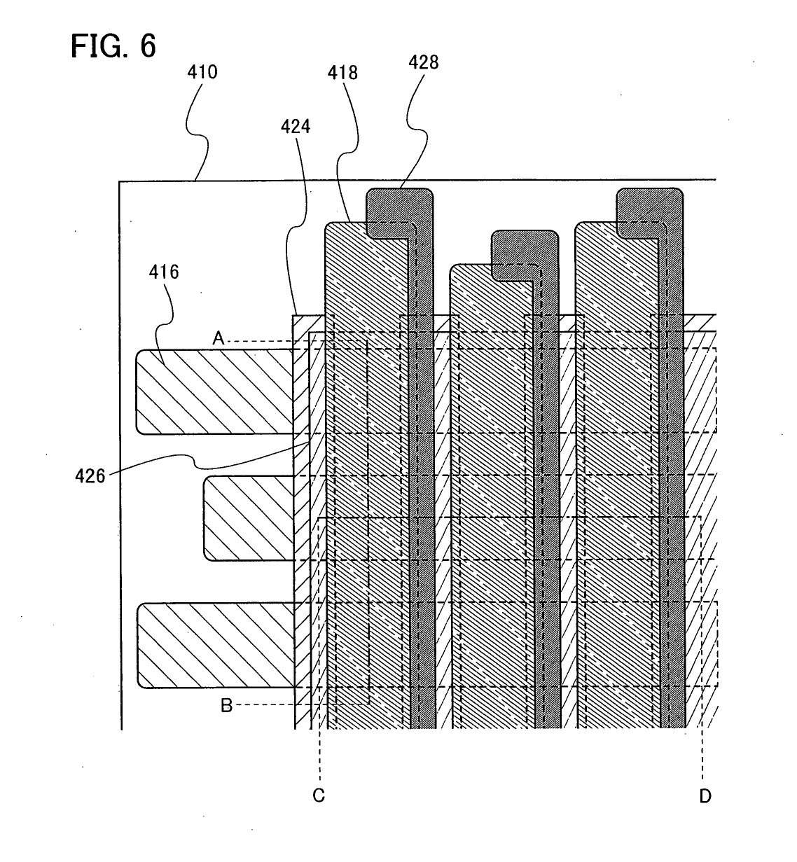

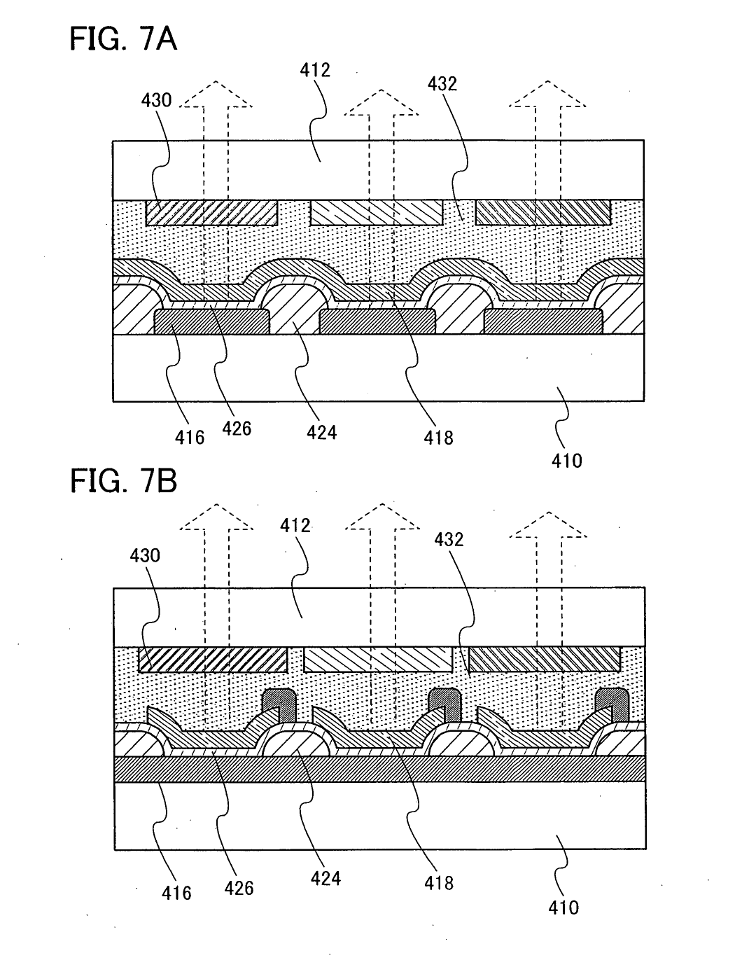

In the present embodiment mode, one aspect of a light-emitting device will be explained with reference to FIG. 4, FIG. 5, FIG. 6, and FIGS. 7A and 7B.

FIG. 4 is a schematic configuration diagram showing a main part of a display device. A first electrode 416 and a second electrode 418, which extends in a direction of intersection with the first electrode 416, are provided over a substrate 410. At the very least, at an intersection of the first electrode 416 and the second electrode 418, a light-emitting layer which is the same as the one described in Embodiment Mode 2 is provided, and a light-emitting element is formed. In the light-emitting device of FIG. 4, a display 414 is formed in which a plurality of the first electrodes 416 and a plurality of the second electrodes 418 are arranged and light-emitting elements acting as pixels are arranged in matrix. In this display 414, the potentials of the first electrode 416 and the second electrode 418 are controlled, and emission of light and non-emission of light for individual light-emitting elements are controlled, whereby video and still images can be displayed.

In this light-emitting device, a signal for displaying images is applied to each of the first electrode 416 extending in one direction of the substrate 410 and the second electrode 418 extending in a direction that intersects with the direction in which the first electrode 416 extends, whereby emission of light or non-emission of light for a light-emitting element is selected. That is, the light-emitting device is a passive matrix display device in which pixel driving is performed by a signal received exclusively from an external circuit. For this kind of display device, because the structure is simple, even if the area is enlarged, the display device can be easily manufactured.

In the above, if aluminum, titanium, tantalum, or the like is used for the first electrode 416 and indium oxide, indium tin oxide (ITO), indium zinc oxide (IZO), or zinc oxide is used for the second electrode 418, the display device can be set as one in which the display 414 is formed on a counter substrate 412 side. In this case, with a thin oxide film formed over the surface of the first electrode 416 to form a barrier layer, by a carrier blocking effect, luminous efficiency can be increased. If indium oxide, indium tin oxide (ITO), indium zinc oxide (IZO), or zinc oxide is used for the first electrode 416 and aluminum, titanium, tantalum, or the like is used for the second electrode 418, the display device can be set as one in which the display 414 is formed on the substrate 410 side. In addition, if the first electrode 416 and the second electrode 418 are both formed as transparent electrodes, the display device can be set as one with double-sided display.

It is to be noted that the counter substrate 412 may be provided according to necessity; by provision of the counter substrate 412 to match the arrangement of the display 414, the counter substrate 412 can be set as a protector. Even if this counter substrate 412 is not made of a tabular-shaped hardwood, a resin film or an applied resin material can be substituted in for the counter substrate 412. The first electrode 416 and the second electrode 418 are drawn out into the vicinity of the edge of the substrate 410, and a terminal connecting to an external circuit is formed. That is, the first electrode 416 and the second electrode 418 form contact with flexible wiring substrates 420 and 422 in the edge of the substrate 410. For the external circuit, in addition to a controller circuit that controls an image signal, a power supply circuit, a tuner circuit, and the like are included.

FIG. 5 shows a magnified view of a portion of the structure of the display 414. A partition layer 424 is formed on a side edge of the first electrode 416 formed over the substrate 410. Also, at the very least, an EL layer 426 is formed over an exposed surface of the first electrode 416. The second electrode 418 is provided over the EL layer 426. Because the second electrode 418 intersects with the first electrode 416, the second electrode 418 is extended over the partition 424. The partition layer 424 is formed using an insulating material so that short-circuiting does not occur between the first electrode 416 and the second electrode 418. In an area in which the partition layer 424 covers the edge of the first electrode 416, the side edges of the partition layer 424 are made to have an incline so that a step does not become steep, and the partition layer 424 is formed into a so-called tapered shape. The partition layer 424 is set to have this kind of shape, whereby coverage of the EL layer 426 and the second electrode 418 is improved and defects such as cracks, tears, or the like can be eliminated.

FIG. 6 is a plane view of the display 414 and shows the arrangement of the first electrode 416, the second electrode 418, the partition layer 424, and the EL layer 426. When the second electrode 418 is formed as an oxide transparent conductive film of indium tin oxide, zinc oxide, or the like, it is preferable that an auxiliary electrode 428 be formed to reduce resistive losses. In this case, the auxiliary electrode 428 may be formed of a metal with a high melting point, such as titanium, tungsten, chromium, tantalum, or the like, or of a combination of a metal with a high melting point and a metal with low resistance, such as aluminum, silver, or the like.

Cross-sectional views taken along A-B and along C-D in FIG. 6 are shown in FIGS. 7A and 7B. FIG. 7A is a cross-sectional view showing the arrangement of the first electrode 416, and FIG. 7B is a cross-sectional view showing the arrangement of the second electrode 418. The EL layer 426 is formed at an intersection of the first electrode 416 and the second electrode 418, and a light-emitting element is formed in that area. The auxiliary electrode 428 shown in FIG. 7B is over the partition layer 424 and provided so as to be in contact with the second electrode 418. By provision of the auxiliary electrode 428 over the partition layer 424, there is no shielding of light of the light-emitting element formed at the intersection of the first electrode 416 and the second electrode 418, whereby light emitted can be used efficiently. In addition, the auxiliary electrode 428 can be prevented from short-circuiting with the first electrode 416.

In FIGS. 7A and 7B, an example is shown in which a color conversion layer 430 is arranged with the counter substrate 412. The color conversion layer 430 is a layer used for changing the color of emitted light by changing the wavelength of light emitted from the EL layer 426. In this case, it is preferable that light emitted from the EL layer 426 be high-energy blue light or ultraviolet light. For the color conversion layer 430, if layers for conversion to red, green, and blue light are arranged, a display device in which RGB color display is performed can be used. In addition, a colored layer (color filter) can be substituted in for the color conversion layer 430. In that case, the EL layer 426 may be configured to emit white light. A filler 432 is used to secure the substrate 410 and the counter substrate 412 and may be provided as appropriate.

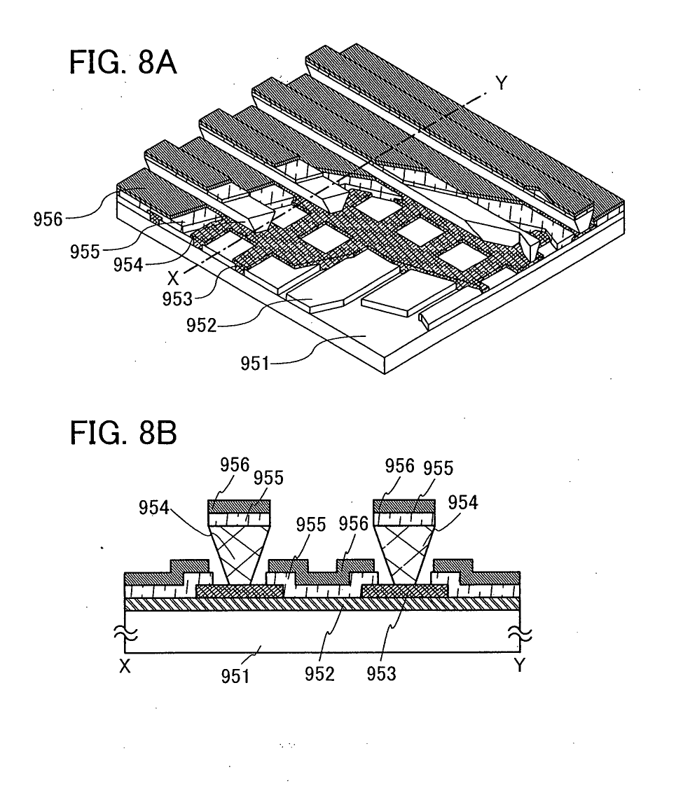

In addition, an alternative structure of the display 414 is shown in FIGS. 8A and 8B. The structure of FIGS. 8A and 8B is one in which an edge of a first electrode 952 is covered by an insulating layer 953. A partition layer 954 is provided over the insulating layer 953, as well. Sidewalls of the partition layer 954 each have a slant so that the space between one sidewall and the other sidewall becomes narrower as it approaches a substrate surface. That is, a cross section in the direction of the short side of the partition layer 954 is trapezoidal, and the lower base (a base facing in the same direction in which the insulating layer 953 is facing and that is in contact with the insulating layer 953) is shorter than the upper base (a base facing in the same direction in which the insulating layer 953 is facing and that is not in contact with the insulating layer 953). In this way, by provision of the partition layer 954, a light-emitting layer 955 and a second electrode 956 can each be formed in a self-aligned manner using the partition layer 954.

The display device of the present embodiment mode is one in which a light-emitting element emits light at low voltage, whereby boosting circuits and the like become unnecessary, and the structure of the device can be simplified.

### Embodiment Mode 5

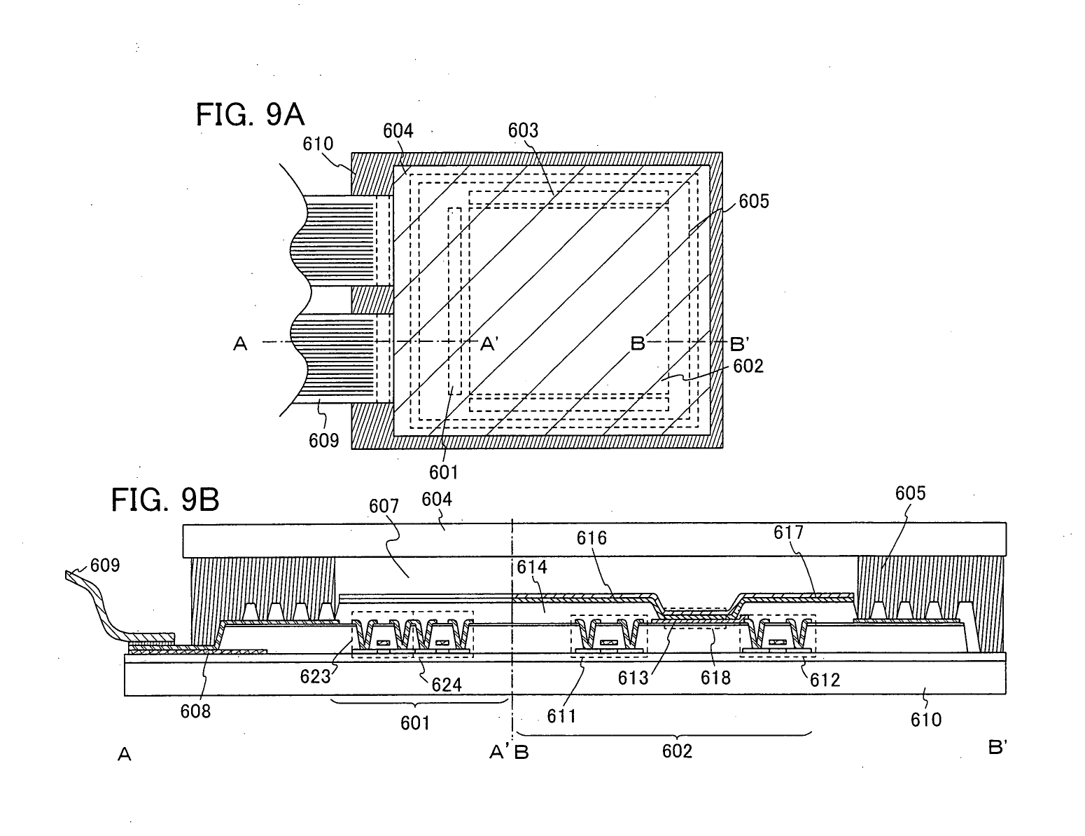

In the present embodiment mode, by a transistor, an active light-emitting device controlling the driving of a light-emitting element manufactured using the present invention in a pixel portion will be explained using FIGS. 9A and 9B. It is to be noted that FIG. 9A is a top view illustrating the light-emitting device, and FIG. 9B is a cross-sectional view of cross sections cut along A-A′ and B-B′ in FIG. 9A. Reference numeral 601 indicated by a dashed line is a driver circuit portion (source-side driver circuit), reference numeral 602 indicated by a dashed line is a pixel portion, and reference numeral 603 indicated by a dashed line is a driver circuit portion (gate-side driver circuit). In addition, reference numeral 604 is a sealing substrate, reference numeral 605 is a sealant, and the inner section of a region enveloped by the sealant 605 is a space 607.

It is to be noted that a lead wiring 608 is a wiring used for transmitting a signal input to the source-side driver circuit 601 and the gate-side driver circuit 603 and receives video signals, clock signals, start signals, reset signals, and the like from an FPC (Flexible Printed Circuit) 609 acting as an external input terminal. It is to be noted that, here, only the FPC is shown, but a printed wiring board (PWB) may be attached to this FPC. The light-emitting device of the present specification includes not only the light-emitting device itself but also a condition in which the FPC or the PWB is attached to the light-emitting device.

Next, a cross-sectional structure will be explained using FIG. 9B. A driver circuit portion and a pixel portion are formed over an element substrate 610, and, here, the source-side driver circuit 601, which is the driver circuit portion, and one of the pixels in the pixel portion 602 are shown.

It is to be noted that the source-side driver circuit 601 is formed of a CMOS circuit that is formed of a combination of an n-channel TFT 623 and a p-channel TFT 624. In addition, for the TFTs forming a driver circuit, the TFTs may be formed as publicly known CMOS circuits, PMOS circuits, or NMOS circuits. Furthermore, in the present embodiment mode, a driver integrated type in which a driver circuit is formed over a substrate is shown, but it is not absolutely necessary that the driver circuit be formed in this way, and the driver circuit may be formed, not over the substrate but externally. It is to be noted that there are no particular limitations on the structure of the TFT. A staggered TFT may be used, or an inverse-staggered TFT may be used. In addition, there are no particular limitations on the crystallinity of a semiconductor film used in the TFT. An amorphous semiconductor film may be used, or a crystalline semiconductor film may be used. Furthermore, there are no particular limitations on the semiconductor materials; an inorganic compound may be used, or an organic compound may be used.

In addition, the pixel portion 602 is formed of a plurality of pixels each including a switching TFT 611, a current controlling TFT 612, and a first electrode 613 electrically connected to a drain of the current controlling TFT 612. It is to be noted that an insulator 614 covering an edge of the first electrode 613 is formed. Here, the insulator 614 is formed using a positive-type photosensitive acrylic resin film.

Furthermore, in order to obtain favorable coverage, a curved surface with curvature is made to be formed over the upper edge or below the lower edge of the insulator 614. For example, when a positive-type photosensitive acrylic is used for the material of the insulator 614, it is preferable that only the upper edge of the insulator 614 be made to have a curved surface having a radius of curvature (from 0.2 μm to 0.3 μm). In addition, for the insulator 614, either a negative-type that becomes insoluble in etchant by radiation of light or a positive-type that becomes soluble in etchant by radiation of light can be used.

An EL layer 616 and a second electrode 617 are each formed over the first electrode 613. At least one of the first electrode 613 and the second electrode 617 has a light-transmitting property, and light can be emitted from the EL layer 616 and drawn to external.

The EL layer 616 includes a light-emitting layer described in Embodiment Modes 1 through 3.

It is to be noted that, for a method for forming the first electrode 613, the EL layer 616, and the second electrode 617, a variety of methods can be used. Specifically, a vacuum vapor deposition method, such as a resistive heating evaporation method, an electron beam vapor deposition (EB vapor deposition) method, or the like; a physical vapor deposition (PVD) method such as a sputtering method or the like; a chemical vapor deposition (CVD) method such as a metal organic CVD method, a low-pressure hydride-transport CVD method, or the like; an atomic layer epitaxy (ALE) method; or the like can be used. Alternatively, an inkjet method, a spin coating method, or the like can be used. Furthermore, every electrode or every layer may each be formed using a different formation method.

Additionally, by affixing of the sealing substrate 604 to the element substrate 610 using the sealant 605, a light-emitting element 618 comes to have a structure in which it is included in the space 607 enclosed by the element substrate 610, the sealing substrate 604, and the sealant 605. It is to be noted that, in the space 607, a filler is filled in, and in addition to the space 607 being filled in with an inert gas (such as nitrogen, argon, or the like), there are cases where the space 607 is filled in with the sealant 605.

It is to be noted that using an epoxy-based resin in the sealant 605 is preferable. In addition, it is preferable that these materials be materials that permeate as little moisture and oxygen as possible. Furthermore, for materials used in the sealing substrate 604, in addition to a glass substrate or a quartz substrate, a plastic substrate made from any of the following can also be used: FRP (Fiberglass-Reinforced Plastics), PVF (polyvinyl fluoride), Mylar (registered trademark), polyester, acrylic, or the like.

As described above, a light-emitting device including a light-emitting element manufactured using the present invention accordingly can be obtained.

The light-emitting device described in the present embodiment mode has the light-emitting element described in Embodiment Modes 1 through 3 and can operate at low driving voltage. For this reason, a light-emitting device in which power consumption is reduced can be obtained.

In addition, the light-emitting device of the present embodiment mode is one in which manufacturing costs for the light-emitting device can be reduced because a driver circuit with a high dielectric strength voltage is unnecessary. In addition, reduction in weight of the light-emitting device and miniaturization of a driver circuit portion can be done.

### Embodiment Mode 6

In the present embodiment mode, an electronic device included in part of the light-emitting device of Embodiment Modes 4 and 5 will be explained. The electronic device described in the present embodiment mode includes the light-emitting element described in Embodiment Modes 1 through 3. By a light-emitting element with high luminance being included, an electronic device with high luminance can be obtained.

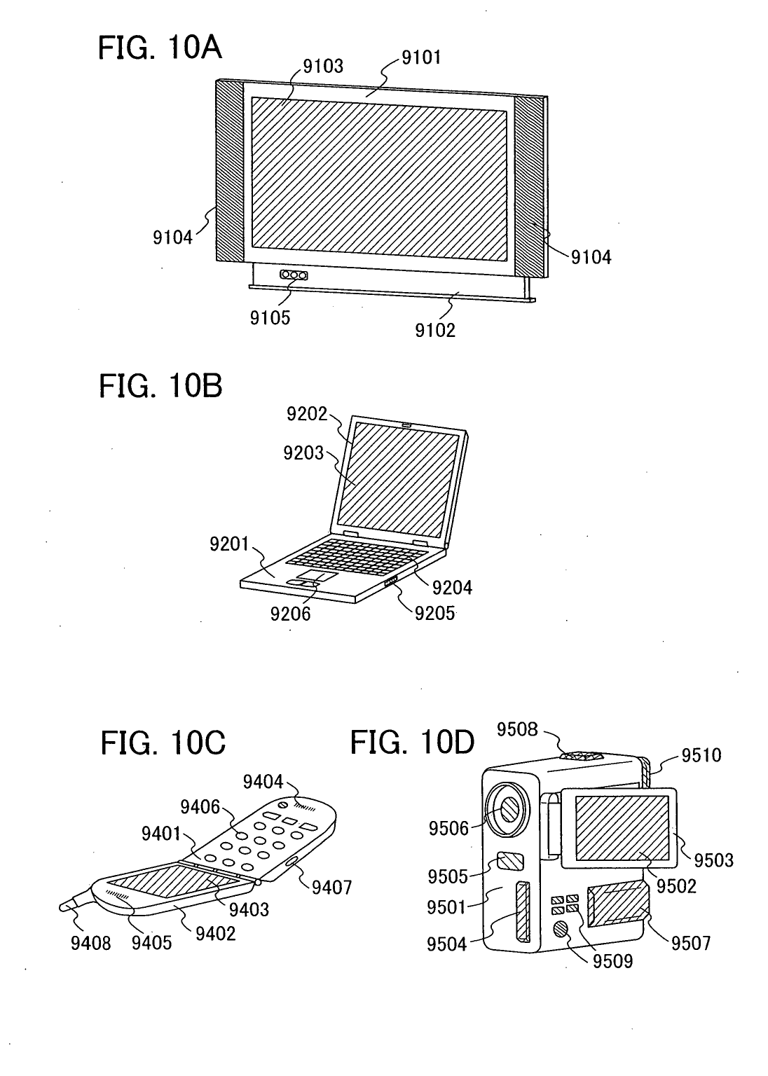

For electronic devices manufactured by application of the present invention, a camera such as a video camera, a digital camera, or the like; a goggle-type display; a navigation system; an audio reproducing system (for example, a car audio system, an audio component system, or the like); a computer; a game machine; a handheld terminal (for example, a portable computer, a cellular telephone, a portable game machine, an electronic book reader, or the like); an image reproducing device provided with a recording medium (specifically, a device that can play storage media such as a DVD (Digital Versatile Disc) and the like and that includes a display device that can display the images); and the like can be given. Some specific examples thereof are shown in FIGS. 10A to 10D.

In FIG. 10A, a television device of the present embodiment mode is shown that includes a housing 9101, a support stand 9102, a display 9103, speakers 9104, video input terminals 9105, and the like. In this television device, the display 9103 is configured with the same light-emitting elements described in Embodiment Modes 3 through 5 arranged in matrix. The light-emitting element has the characteristics that luminous efficiency is high and driving voltage is low. In addition, short-circuiting due to impacts or the like caused by an external source can be prevented. Because the display 9103 configured with those light-emitting elements has the same characteristics, deterioration of image quality for this television device can be reduced, and a shift to low power consumption can be obtained. By these kinds of characteristics, deterioration compensation function circuits and power supply circuits can be greatly reduced in number and in size in the television device, whereby reduction in size and weight of the housing 9101 and the support stand 9102 can be obtained. In the television device of the present embodiment mode, because low power consumption, high image quality, and a reduction in the size and weight of the device can be obtained, a television device adapted for use in an applicable environment can be provided.

The computer of FIG. 10B is a computer of the present embodiment mode and includes a main body 9201, a case 9202, a display 9203, a keyboard 9204, an external connection port 9205, a pointing device 9206, and the like. The display 9203 of this computer is one in which the same light-emitting elements as those described in Embodiment Modes 3 through 5 are arranged in matrix. The light-emitting elements have the characteristics of high luminous efficiency and low drive voltage. In addition, short-circuiting due to impacts or the like caused by an external source can be prevented. Because the display 9203 including the light-emitting elements has the same characteristics, deterioration in the image quality of this computer is reduced and a shift to low power consumption can be achieved. Through such characteristics, because deterioration compensating function circuits and power supply circuits can be greatly reduced in number and in size in the computer, a reduction in the size and weight of the main body 9201 and the case 9202 can be achieved. Because low power consumption, high picture quality, and a reduction in the size and weight of the computer of the present embodiment mode can be achieved, a device adapted for use in an applicable environment can be provided thereby. In addition, the computer can be carried, and a computer that has a display which is able to withstand impacts by an external source that occur when it is being carried can be provided.

The cellular phone of FIG. 10C is a cellular phone of the present embodiment mode and includes a main body 9401, a case 9402, a display 9403, an audio input 9404, an audio output 9405, operation keys 9406, an external connection port 9407, an antenna 9408, and the like. The display 9403 of this cellular phone is one in which the same light-emitting elements as those described in Embodiment Modes 3 through 5 are arranged in matrix. The light-emitting elements have the characteristics of high luminous efficiency and low drive voltage. In addition, short-circuiting due to impacts or the like caused by an external source can be prevented. Because the display 9403 including the light-emitting elements has the same characteristics, deterioration in the image quality of this cellular phone is reduced and a shift to low power consumption can be achieved. Through such characteristics, because deterioration compensating function circuits and power supply circuits can be greatly reduced in number and in size in the cellular phone, a reduction in the size and weight of the main body 9401 and the case 9402 can be achieved. Because low power consumption, high picture quality, and a reduction in the size and weight of the cellular phone of the present embodiment mode can be achieved, a device adapted for portable use can be provided thereby. In addition, a cellular phone that has a display which is able to withstand impacts by an external source that occur when it is being carried can be provided.

The camera of FIG. 10D is a camera of the present embodiment mode and includes a main body 9501, a display 9502, a case 9503, an external connection port 9504, a remote control receiver 9505, an image receiver 9506, a battery 9507, an audio input 9508, operation keys 9509, an eyepiece 9510, and the like. The display 9502 of this camera is one in which the same light-emitting elements as those described in Embodiment Modes 3 through 5 are arranged in matrix. The light-emitting elements have the characteristics of high luminous efficiency and low drive voltage, and short-circuiting due to impacts or the like caused by an external source can be prevented. Because the display 9502 including the light-emitting elements has the same characteristics, deterioration in the image quality of this camera is reduced and low power consumption can be achieved. Through such characteristics, because deterioration compensating function circuits and power supply circuits can be greatly reduced in number and in size in the camera, a reduction in the size and weight of the main body 9501 can be achieved. Because low power consumption, high picture quality, and a reduction in the size and weight of the camera of the present embodiment mode can be achieved, a device adapted for portable use can be provided thereby. In addition, a camera that has a display which is able to withstand impacts by an external source that occur when it is being carried can be provided.

As described above, the scope and field of application of the light-emitting device of the present invention are extremely wide, and it is possible to apply the light-emitting device to electronic devices of any field. Use of the light-emitting device of the present invention allows an electronic device with a highly reliable display with low power consumption to be provided.

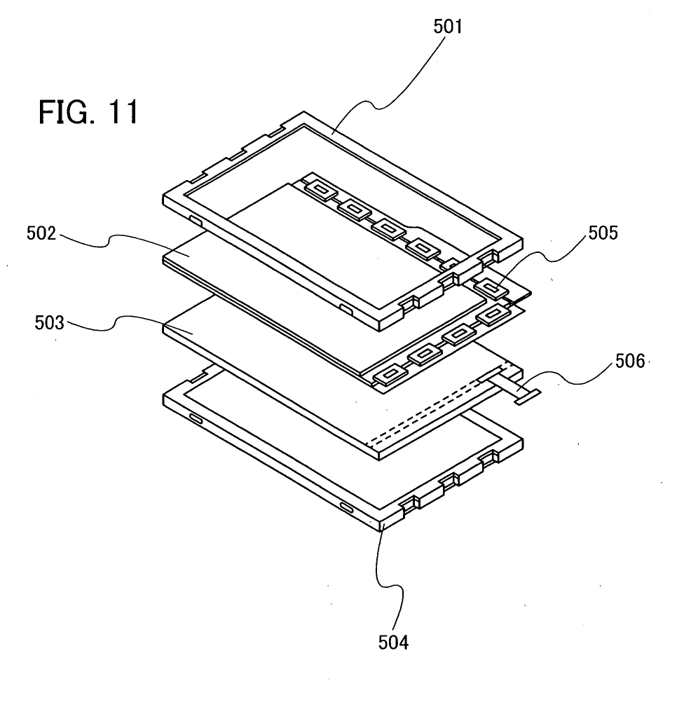

In addition, the light-emitting device employing the present invention can be used for a lighting system. An example of a light-emitting device employing the present invention which can be used for a lighting system will be explained using FIG. 11.

FIG. 11 is an example of a liquid crystal display device using the light-emitting device employing the present invention as a backlight. The liquid crystal display device shown in FIG. 11 includes a housing 501, a liquid crystal layer 502, a backlight 503, and a housing 504; the liquid crystal layer 502 is connected to a driver IC 505. In addition, the light-emitting device of the present invention is used for the backlight 503, and a voltage is applied to a terminal 506.

By use of the light-emitting device of the present invention as a backlight for a liquid crystal display device, a backlight with a high luminance and a long life can be obtained, and the quality of the display device is improved. In addition, for the light-emitting device of the present invention, because the light-emitting device emits light by surface light emission and a shift to a large area can be achieved, a shift to a large area for the backlight can be achieved as well, and a shift to a large area for the liquid crystal display device can also be achieved. Furthermore, because the light-emitting element is thin, a liquid crystal display device in which the backlight has been thinned can be provided.

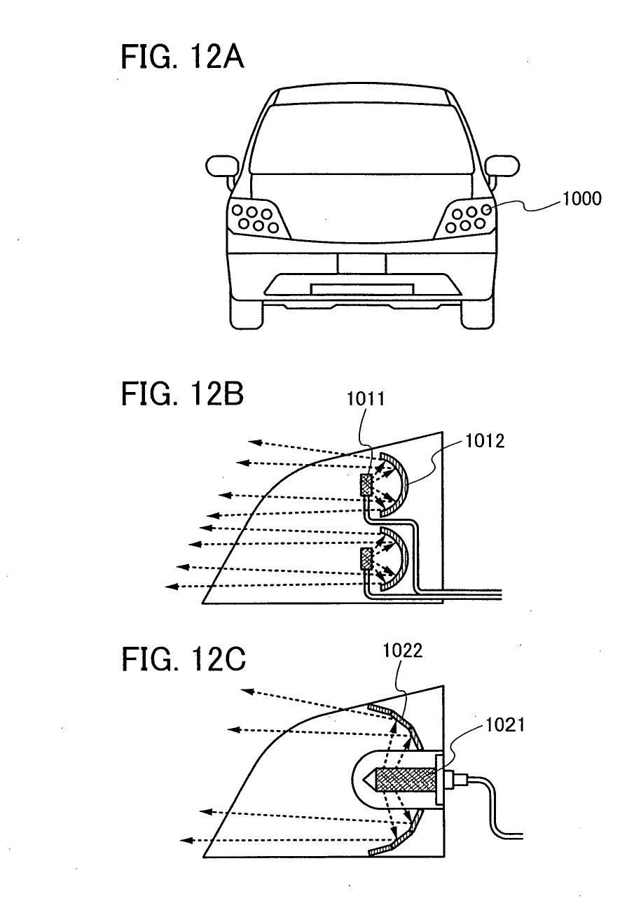

In addition, because the light-emitting device to which the present invention is employed is one in which light can be emitted at high luminance, the light-emitting device can be used for a headlight of a car, bicycle, ship, or the like. FIGS. 12A to 12C show examples of the light-emitting device to which the present invention is employed used as a headlight for a car. FIG. 12B is an enlarged cross-sectional view of part of a headlight 1000 shown in FIG. 12A. In FIG. 12B, the light-emitting device of the present invention is used as a light source 1011. Light emitted from the light source 1011 is reflected from a reflector plate 1012 and extracted to external. As shown in FIG. 12B, by use of a plurality of light sources, light with an even higher luminance can be obtained. In addition, FIG. 12C is an example in which the light-emitting device of the present invention manufactured into a cylindrical shape is used as a light source. Light emitted from a light source 1021 is reflected from a reflector plate 1022 and extracted to external.

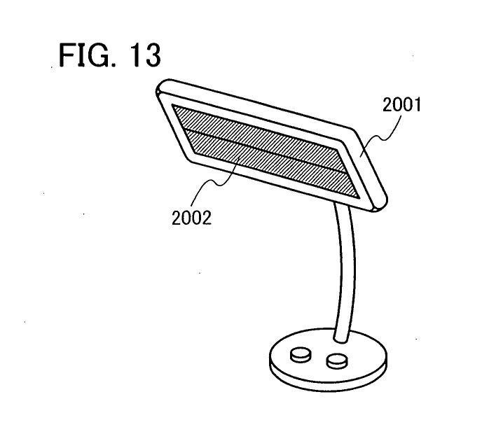

FIG. 13 shows an example in which the light-emitting device to which the present invention is employed is used as a desk lamp of a lighting system. The desk lamp shown in FIG. 13 has a housing 2001 and a light source 2002, where the light-emitting device of the present invention is used for the light source 2002. Because the light-emitting device of the present invention is one in which light can be emitted at high luminance, when detailed work or the like is being performed, the area at hand where the work is being performed can be brightly lighted up.

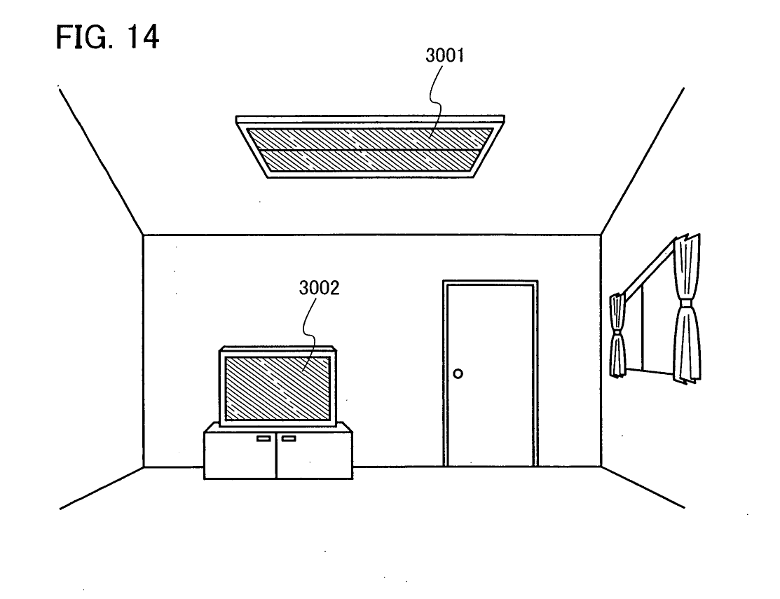

FIG. 14 shows an example in which the light-emitting device to which the present invention is employed is used as an indoor lighting system 3001. Because a shift to a large area can be made for the light-emitting device of the present invention, the light-emitting device can be used for a lighting system with a large area. In addition, because the light-emitting device of the present invention is one which is thin and which operates at low power consumption, the light-emitting device can be used for a lighting system which can be made thinner and in which power consumption can be lowered. In this way, in a room in which the light-emitting device employing the present invention is used for the indoor lighting system 3001, as illustrated in FIG. 10A, a television device 3000 of the present invention can be set up, and viewing of public broadcast programming or films can be enjoyed. In this kind of case, because both devices operate at low power consumption, viewing of powerful images can be enjoyed in a brightly lit room, without any worry about the electric bill.

The lighting system to which the light-emitting device of the present invention is applied is not limited to the examples shown in FIGS. 12A to 12C, 13, and 14; beginning with lighting for residential homes and public facilities, the light-emitting device of the present invention can be applied to a variety of modes of lighting systems. In this kind of case, because a light-emitting medium of the lighting system of the present invention is a thin film, the degree of freedom in designing is high, whereby a variety of elaborately-designed products can be promoted in the marketplace.

This application is based on Japanese Patent Application serial No. 2006-155473 filed in Japan Patent Office on Jun. 2, 2006, the contents of which are hereby incorporated by reference.

What is claimed is:

1. A light-emitting element comprising:
a light-emitting layer interposed between a pair of electrodes,
wherein the light-emitting layer comprises a first layer and a second layer,
wherein the first layer contains a material acting as a luminescent center,
wherein the second layer contains a host material and the material acting as a luminescent center, and
wherein the second layer is in contact with the first layer.

2. A light-emitting element according to claim 1,
wherein the host material is selected from any of zinc sulfide, cadmium sulfide, calcium sulfide, yttrium sulfide, gallium sulfide, strontium sulfide, barium sulfide, zinc oxide, yttrium oxide, aluminum nitride, gallium nitride, indium nitride, zinc selenide, zinc telluride, barium aluminum sulfide, calcium gallium sulfide, strontium gallium sulfide, and barium gallium sulfide.

3. A light-emitting element according to claim 1,
wherein the first layer containing the material acting as a luminescent center contains at least one element selected from copper, silver, gold, manganese, terbium, europium, thulium, cerium, praseodymium, samarium, erbium, aluminum, chlorine, and fluorine.

4. A light-emitting element according to claim 1, further comprising an insulating layer,
wherein the insulating layer is interposed between the pair of electrodes.

5. A light-emitting element according to claim 4,
wherein the insulating layer contains at least one selected from yttrium oxide, titanium oxide, aluminum oxide, hafnium oxide, tantalum oxide, silicon oxide, barium titanate, strontium titanate, lead titanate, silicon nitride, and zirconium oxide.

6. A light-emitting device comprising:
the light-emitting element described in claim 1 and a controlling means for controlling light emitted by the light-emitting element.

7. An electronic device comprising:
a display,
wherein the display is equipped with the light-emitting element of claim 1 and a controlling means for controlling light emitted by the light-emitting element.

8. A manufacturing method for a light-emitting element comprising:
a step for forming a first electrode;
a step for forming a light-emitting layer over the first electrode;
a step for forming a second electrode over the light-emitting layer; and
a step for performing heat treatment on the light-emitting layer,
wherein the step for forming the light-emitting layer includes a step for forming a layer containing a host material and a step for forming layer containing a material acting as a luminescent center, so that the layer containing the host material and the layer containing the material acting as a luminescent center are in contact with each other.

9. A manufacturing method for the light-emitting element according to claim 8,
wherein the host material is selected from any of zinc sulfide, cadmium sulfide, calcium sulfide, yttrium sulfide, gallium sulfide, strontium sulfide, barium sulfide, zinc oxide, yttrium oxide, aluminum nitride, gallium nitride, indium nitride, zinc selenide, zinc telluride, barium aluminum sulfide, calcium gallium sulfide, strontium gallium sulfide, and barium gallium sulfide.

10. A manufacturing method for the light-emitting element according to claim 8,
wherein the layer containing the material acting as a luminescent center contains at least one element selected from copper, silver, gold, manganese, terbium, europium, thulium, cerium, praseodymium, samarium, erbium, aluminum, chlorine, and fluorine.

11. The manufacturing method for the light-emitting element according to claim 8,
wherein a step for forming an insulating layer is performed before the step for forming the second electrode is performed.

12. The manufacturing method for the light-emitting element according to claim 11,
wherein the insulating layer contains at least one selected from yttrium oxide, titanium oxide, aluminum oxide, hafnium oxide, tantalum oxide, silicon oxide, barium titanate, strontium titanate, lead titanate, silicon nitride, and zirconium oxide.
